(19) United States
(12) Patent Application Publication
(10) Pub. No.: US 2008/0217107 A1
(43) Pub. Date: Sep. 11, 2008

(54) SELF LUBRICATING PIN ASSEMBLY

(75) Inventor: R. Kyle SCHMIDT, Bailly (FR)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: MESSIER-DOWTY INC., Ajax (CA)

(21) Appl. No.: 12/024,631

(22) Filed: Feb. 1, 2008

Related U.S. Application Data
(60) Provisional application No. 60/899,006, filed on Feb. 2, 2007.

(51) Int. Cl. F16N 11/10; B64C 25/02

(52) U.S. Cl. 184/39; 244/100 R

(57) ABSTRACT

This invention provides a pin assembly that is self-lubricating and includes a pin, a pin insert that is received within the pin and a quantity of lubricating agent. The present invention also provides an insert for a pin that may be used in a pin joint that contains an automatic lubrication dispensing mechanism.

### CROSS-REFERENCE TO RELATED APPLICATION

The present application claims the benefit under 35 U.S.C. §119(e) of provisional patent application Ser. No. 60/899,006 filed Feb. 2, 2007, the contents of which are hereby incorporated by reference.

### FIELD OF THE INVENTION

The present invention relates to aircraft landing systems and more particularly to an apparatus for providing measured or continuous greasing of pin joints to reduce or eliminate scheduled maintenance.

### BACKGROUND OF THE INVENTION

Every retractable landing gear is, by necessity, composed of links that fold and rotate during stowage. The technology of these rotating joints has not progressed significantly over the years. They are essentially static joints which must take large loads during landing and ground manoeuvring operations, then rotate in an essentially unloaded state during retraction or extension once the aircraft is off the ground.

The standard solution for these joints is a steel pin (which may, for example, be coated with chrome or high velocity oxygen fuel (HVOF) applied WCCoCr) running in a bronze (or Aluminum-bronze or Beryllium-Bronze) bushing. These materials are merely examples of the type of interface materials that may be used. The bushing is pressed into a hole in the surrounding structure. The joint is greased manually and periodically to avoid excessive metal on metal contact. In addition to the lubrication function served by the grease, the greasing action helps displace moisture and dirt that may collect in the pin-bushing interface. Thus, regular greasing helps minimize corrosion and wear.

The pin joints typically used in landing gear applications employ pins that are hollow in order to optimize the strength while minimizing the weight (weight being a significant factor in all aircraft). The hollow pin is typically filled with a plastic ‘grease insert’ that has internal channels that act as grease distribution tubes, delivering grease from a grease fitting on the external edge of the insert, to holes in the interior of the grease insert. The grease exits from these points, and travels through holes in the pin to the pin/bushing interface.

One reason why these joints have not advanced significantly over the years is that they are a good solution to the problem. Although various material improvements may be made and tried, at its core, the design solution is solid. The primary drawback is that the joint must be thoroughly and regularly greased to ensure continued proper behaviour of the joint.

In today's operational environment, a regular maintenance requirement, i.e. greasing, is seen as a drawback because the industry demand is for maintenance free joints. Eliminating the maintenance requirement by eliminating greasing only results in increased corrosion and wear in components which jeopardizes safety and increases overhaul costs. Changing the material specifications to ‘self lubricating’ materials such as oil impregnated bushings or Teflon materials and the like increases the joint cost, but also has not shown sufficient performance in operation, both in strength and lubrication/corrosion protection.

The present invention provides a solution that not only works for new design components, but also may be retrofitted to existing joints to overcome some of the problems discussed above.

### SUMMARY OF THE INVENTION

In one aspect, the present invention provides a lubricating pin insert for use in a hollow pin, the pin having at least one aperture within it. The lubricating pin insert includes a body having a chamber that is operable to receive a quantity of a lubricating agent, the body also includes at least one passageway in fluid communication with the chamber and configured to align with the at least one aperture of the pin when the insert is received in the pin. The pin insert also includes a dispensing means connected to the chamber that is operable to dispense a quantity of lubricating agent from the chamber through the at least one passageway.

In one embodiment the pin insert includes, as the dispensing means, a pressure producing means that is connected to the chamber and further a floating piston that is received within the chamber between the quantity of lubricating agent and the pressure producing means. The pin insert may also include at least one lubrication inlet connected to the chamber to allow for passage of the lubricating agent into the chamber.

In another aspect the present invention provides a pin assembly for use in a pin joint on an aircraft landing gear, comprising a pin having a hollow body and at least one aperture therein and a pin insert as described herein.

In an alternative aspect the present invention provides a pin for use in a pin joint on an aircraft landing gear, comprising a pin having a hollow body operable to receive a quantity of a lubricating agent and comprising at least one passageway that is operable to allow passage of the lubricating agent from the body out of the pin. The pin further includes dispensing means connected to the body and operable to dispense a quantity of lubricating agent therefrom. The pin may also include at least one lubrication inlet to allow for refilling of the pin with the lubricating agent.

### BRIEF DESCRIPTION OF THE DRAWINGS

The present invention will be described further below with reference to the following figures:

FIG. 1 is a schematic of a standard grease insert that allows for grease migration from a grease gun fitted to the lubrication fitting to the lubrication holes between the seal lands;

FIG. 2 is a schematic of an example pin into which the grease insert depicted in FIG. 1 fits;

FIG. 3 is a schematic of the pin of FIG. 2, the grease fitting of FIG. 1 in an assembly with the bushings and remainder of the pin joint components;

FIG. 4 is a cross-sectional view of the embodiment of the pin insert of the present invention including a battery and electrical gas generator to move the grease;

FIG. 5 is a cross-sectional view of an alternate embodiment of the pin insert of the present invention including a battery, motor, and gear reduction drive with lead screw to dispense the grease; and

FIG. 6 is a cross-sectional view of an alternate embodiment of the pin insert of the present invention including an external lever arm driving a ratchet and gear reduction/lead screw to dispense the grease.

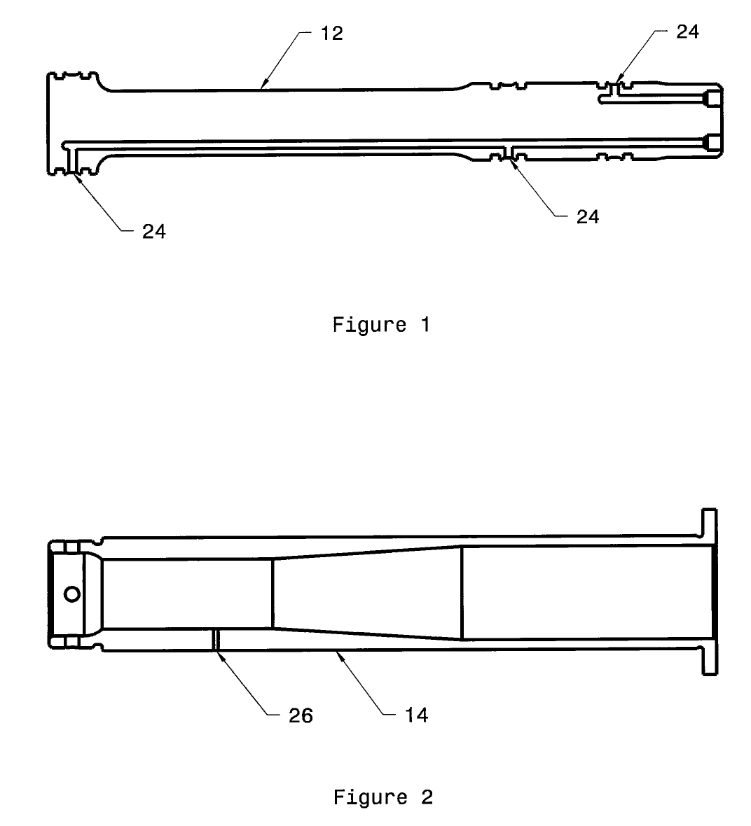

### DETAILED DESCRIPTION OF THE PREFERRED EMBODIMENTS

The present invention provides a pin assembly that is self lubricating. The present invention also provides an insert for a pin that may be used in a pin joint that contains an automatic lubrication dispensing mechanism. The pin insert stores in its hollow interior a quantity of grease that is dispensed into the joint over time. Maintenance of the joint is eliminated completely, or reduced to a grease reservoir refill which is required much less frequently than the current maintenance action. An additional benefit is that the joint stays properly greased at all times ensuring low corrosion risk and low wear to the mating surfaces.

The invention is composed of four principle components: the body of the grease insert, a quantity of stored grease, an actuation mechanism to displace the grease through the lubrication holes, and a control mechanism to determine when the actuation mechanism should activate.

The present invention will now be described in detail with reference to the accompanying figures. The present invention will be described with reference to one embodiment in which the pin assembly comprises a pin insert. However, it will be understood that the present invention also provides a pin assembly in which the components that are described herein as being a pin insert are integral with the pin assembly, i.e. are formed within the pin assembly and not as a separate insert component.

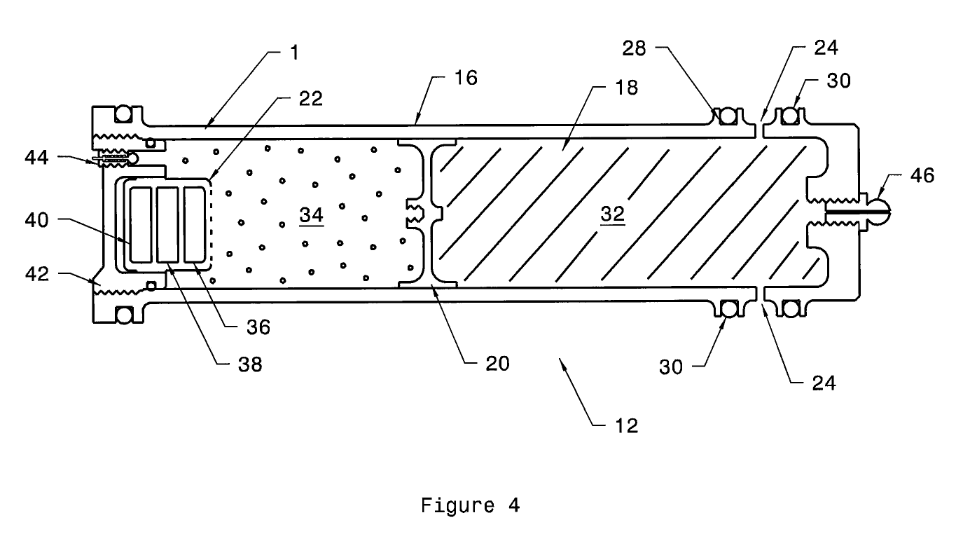

Turning to FIG. 3, the pin assembly of the present invention is indicated generally at numeral 10. The pin assembly 10 comprises a pin insert 12 and a pin 14, shown in FIG. 3. As stated above, it will be understood that the present invention provides a pin assembly comprising both of these components and also provides a pin insert 12 for use in a retrofitted pin used in an existing joint.

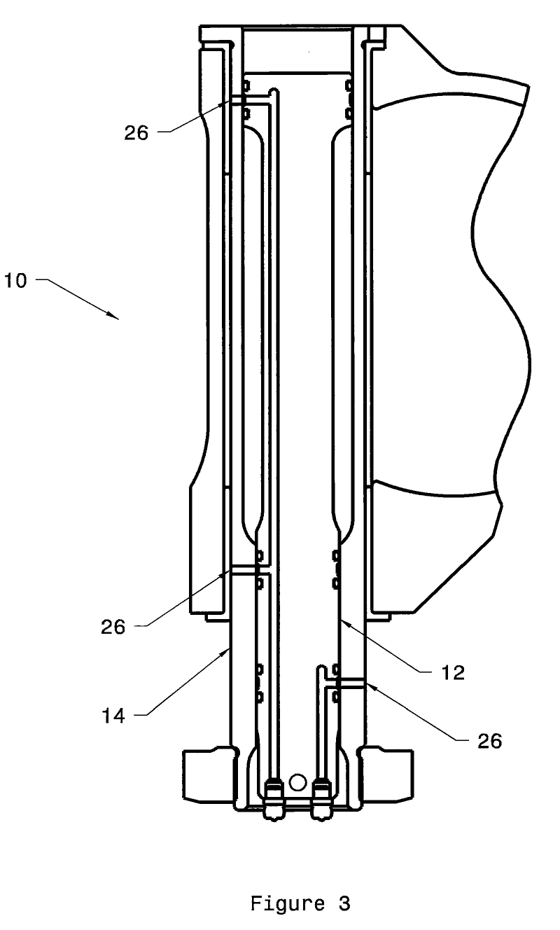

The pin 14 is a hollow pin typically used in pin joints in aircraft landing gear. A person skilled in the art will know the types of pins that are used and the preferred size and configuration for each application. An example of the dimensions of a pin that may be used is illustrated in FIG. 2. However it will be understood that the dimensions provided merely serve as an example and are not meant to be limiting in any way.

As illustrated in FIGS. 4-6, the pin insert 12 includes an insert body 16 that includes a chamber 18 that is configured to receive and store a quantity of grease.

As can be seen more clearly in FIGS. 4-6 the chamber 18 is centrally located within the insert body 16 and extends along the length of the insert body 16. The chamber 18 is sized to receive a sufficient quantity of grease to allow for lubrication of the pin joint over a predetermined quantity of time. It will be understood that the size of the chamber 18 may vary and also the quantity of the grease received in the chamber 18 may vary depending on the user requirements.

The pin insert 12 also includes a dispensing means 20 to dispense the grease out of the chamber 18 and control means 22 for controlling the dispensing means 20. These two components may be separate or may form a unitary component, seen in FIGS. 4-6.

The insert body 16 includes at least one insert aperture 24 that extends into the chamber 18 to allow for the passage of grease from the chamber 18 through the insert body 16 and out of the insert 12 and through at least one corresponding pin aperture 26, into the pin joint. It will be understood that the term apertures refers to either a hole in the wall/exterior surface of the insert that reaches the inner chamber or a passageway that passes through the exterior wall of the insert into the chamber 18. The terms aperture and passageway may be used interchangeably when describing either the pin insert aperture or the pin aperture.

As can be seen in FIG. 3, the pin 14 includes pin apertures 26 that correspond to the insert apertures 24.

The pin insert 12 may be a plastic tube that is sized to be received within the pin 14. As an example, the pin insert 12 may be formed from a high strength thermoplastic material, for example Delrin™. However, it will be understood that the grease insert 12 is not limited to such material and may be formed from any suitable material, for example, such as metal or any composite material. In the illustrated embodiment (e.g. shown in FIG. 4), the pin insert 12 includes a plurality of grooves 28 located around the exterior surface for receiving sealing means 30, for example an O-ring, to secure the pin insert 12 in the pin 14. Other means may be used to ensure a sufficient fit between the insert 12 and the pin 14 that holds the insert within the pin and allows for the passage of a lubricating agent 32, i.e. grease, therethrough.

The stored lubricating agent/grease 32 may be of any type of lubricating agent that is suitable for the lubrication of the pin and of an appropriate viscosity to allow it to flow under effort from the actuation mechanism through the lubrication holes into the pin joint.

Located within, or connected to, the pin insert 12 is dispensing means 20. The dispensing means 20 is operable to provide the motive effort to move a quantity of lubricating agent 32 from the chamber 18 in the pin insert 12 through the insert aperture(s) 24. The dispensing means 20 may be, for example, a piston that is moved within the chamber 18 by a battery powered gas generator; or a piston that is moved within the chamber by a battery powered electrical actuator; or a piston that is moved within the chamber 18 by a mechanically actuated rotary to linear gear mechanism. It will be understood that these examples are not meant to be limiting. It will be understood that the piston and the means to move the piston, as described above, may be a unitary component or may be separate components that are connected.

Connected to the dispensing means 20 is control means 22, which may vary depending on the dispensing means 20. For example, in the case of the battery powered systems, a tilt switch and timer relay or tilt sensor and timer electronics may be configured to provide a timed amount of actuation following a gear retraction event. In this manner, a small amount of grease is dispensed each flight, and during non-loaded operation of the landing gear. This allows the grease to move freely. In the case of the mechanical actuation system, a linkage connects the rotating and non-rotating portions of the landing gear that the pin is connecting. The linkage drives a ratchet mechanism which turns a lead screw. The lead screw is attached to a piston head in such a manner that rotation of the landing gear component drives the piston head in one direction only—to compress and dispense the grease. The ratchet mechanism is selected such that flexure of the landing gear components during ground operations do not provide sufficient rotation to provide indexing of the ratchet and drive of the lead screw.

Different embodiments of the dispensing means and control means will now be discussed in reference to FIGS. 4-6.

Turning to FIG. 4, in one embodiment the pin insert 12 includes as the dispensing means 20 a floating piston located within the chamber 18. The floating piston is sized to fit within the chamber 18 extending across the complete width of the chamber to provide a barrier like structure within the chamber to push against the lubricating agent 32. The floating piston provides a sealed, translating barrier that extends across the chamber. The control means 22 comprises a gas generator module that is located at the opposing end of the chamber 18 to the insert aperture(s) 24.

A quantity of lubricating agent/grease 32 is stored in the chamber 18 between the end of the insert 12 and a floating piston 20. The lubricating agent 32 is forced to exit from the insert aperture(s) 24 by the pressure of a gas 34 acting on the floating piston 20 and hence on the quantity of grease 32. The gas 34 is produced by a gas generation module 22 containing an electrochemical gas generator 36 and switch and timing circuit 38 and a battery 40. The gas generator module 22 is fixably attached to the end of the pin insert 12 using a pin end cap 42 which is threaded or otherwise allows a fixable attachment to the pin insert 12. The end cap 42 also contains an externally actuated check valve 44 which allows the pressurized gas 34 to be vented to atmosphere during the manual addition of new grease in to the chamber 18 through a lubrication fitting 46 located at the end of the chamber 18.

In this embodiment the battery 40 is preferably of a lithium thionyl chloride chemistry allowing long service life and operation at temperatures as low as −55° C. However, other batteries may be used that allow for long service life and are operable within the temperature ranges to which the component will be exposed. The switch and timing circuit 38 may be of electronic or electromechanical means containing a tilt switch, timing circuit, and control switch such that upon movement of the pin insert from one orientation (landing gear extended) to another orientation (landing gear retracted), the tilt switch will close, enabling the timing circuit. The timing circuit will be energized by the battery 40 through the tilt switch and will turn on the control switch for a suitable period of time to activate the electrochemical gas generator 36 and create sufficient gas volume to displace the desired quantity of grease. Following this time the timing circuit will open the control switch, curtailing gas production.

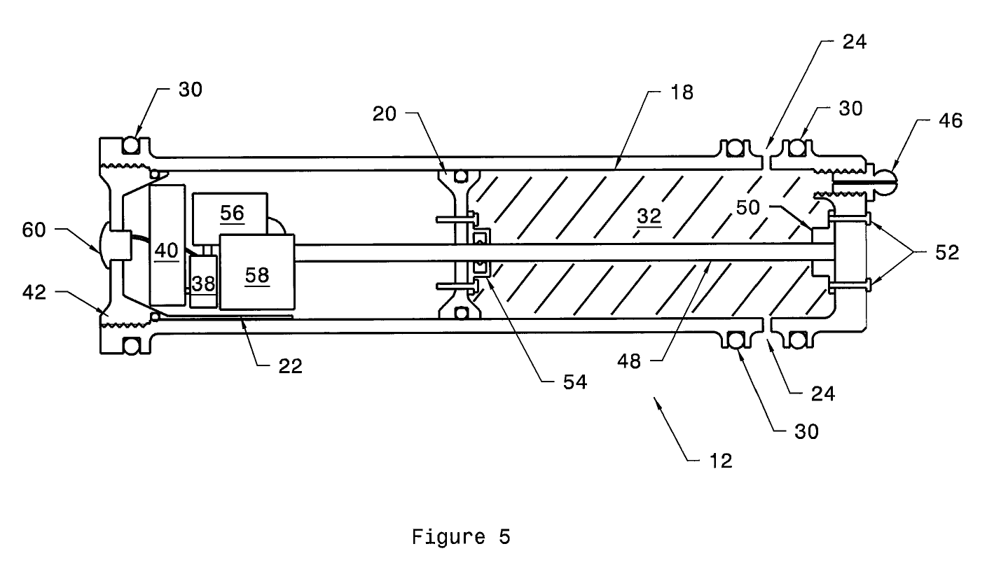

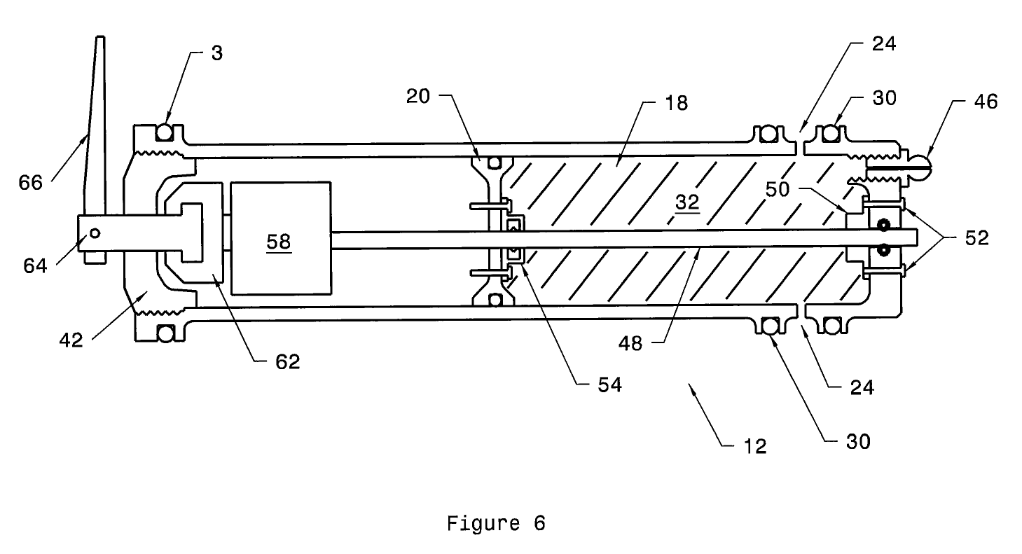

In another embodiment, mechanical force generated by a lead screw (ball screw) is used to displace the grease. The gas generator is not used. In this embodiment, illustrated in FIG. 5, pin insert 12 is formed as described above. A quantity of lubricating agent 32 is stored in the insert between the end of the insert and a floating piston 20. The lubricating agent 32 is forced to exit from the apertures 24 by the force of the floating piston 20 on the lubricating agent 32. The floating piston 20 is activated by the turning of a lead screw 48 which turns freely in a bearing 56 fixably attached to the end of the pin insert 12 by bolts 52 or other suitable means. The turning of the lead screw 48 drives a nut 54 that is mounted on the floating piston 20. The movement of the lead screw 48 is driven by control means 22 that includes an electric motor 56 turning a gear reduction unit 58 to develop the required force. A battery 40 and switch and timing circuit 38 control the operation of the electric motor 56. The battery 40, switch and timing circuit 38, motor 56 and gear reduction unit 58 are fixably attached to the pin insert 12 at pin end cap 42 which is threaded or otherwise allows a fixable attachment to the pin insert 12. The end cap 42 may also contain an externally actuated electric switch 60 which drives the ballscrew in reverse during the manual addition of new grease in to the chamber 18 through a lubrication fitting 46.

In this embodiment the battery 40 is preferably of a lithium thionyl chloride chemistry allowing long service life and operation at temperatures as low as −55° C. The switch and timing circuit 38 may be of electronic or electromechanical means containing a tilt switch, timing circuit, and control switch such that upon movement of the pin insert from one orientation (landing gear extended) to another orientation (landing gear retracted), the tilt switch will close, enabling the timing circuit. The timing circuit will be energized by the battery 40 through the tilt switch and will turn on the control switch for a suitable period of time to activate the electric motor 56 for a sufficient time to displace the desired quantity of grease. Following this time the timing circuit will open the control switch, curtailing motor operation.

In a further embodiment, illustrated in FIG. 6, the mechanical drive system to displace the grease is mechanically coupled to the components of the landing gear. In this embodiment, grease insert 12 may be formed as described above. However, it will be understood that the grease insert 12 is not limited to such material and may be formed from any suitable material, for example, such as metal or any composite material. A quantity of grease 32 is stored in the insert between the end of the insert and a floating piston 20. As discussed above, the grease 32 is forced to exit from the apertures 24 by the force of a floating piston 20 on the grease 32. The floating piston 20 is activated by the turning of a lead screw 48 which turns freely in a bearing 50 fixably attached to the end of the pin insert 12 by bolts 52 or other suitable method. The turning of the lead screw 48 drives a nut 54 which is mounted on the floating piston 20. The movement of the lead screw 48 is driven by control means 22 that includes a gear reduction unit 58 which is connected to a ratchet mechanism 62 which in turn is connected to a drive shaft 64 which is configured to only advance the gear reduction unit 58 when the drive shaft 64 is turned in one direction. Drive shaft 64 is free to rotate in the opposite direction without turning the gear reduction unit 58 or the lead screw 48. The drive shaft 64 passes through an end cap 42 to the exterior of the pin insert 12.

A mechanism represented in this instance by a simple lever arm 66 may be connected to the drive shaft 64 in such a manner that relative movement between the pin insert 12 and the surrounding structure during retraction and extension of the landing gear will drive the drive shaft 64. In this manner, the system shall be configured such that during retraction of the landing gear, the drive shaft 64 will rotate, engaging the ratchet 62 and turning the gear reduction unit 58. The output of the gear reduction unit 58 will be tailored to turn the lead screw 48 a sufficient amount to dispense the required quantity of grease 32. During the opposite motion of the landing gear, the drive shaft 64 will freely turn without dispensing grease 32. The ratchet mechanism 62 shall be configured such that relative movement of the pin insert and the surrounding structure during ground manoeuvring of the aircraft will not sufficiently advance the ratchet and pawl mechanism to drive the gear reduction unit 58. This will ensure that grease is only dispensed during unloaded operation of the landing gear and will keep undo loads from the grease dispensing mechanism.

To facilitate reloading of the grease 32, a lubrication fitting 46 is attached into the body of the pin insert 12 and the lead screw shaft 48 is extended through the end of the pin insert 12 and made to form a shape drivable by standard tools, such as a hex driver. The ratchet mechanism 62 shall accept the lead screw 48 being backdriven without rotating the drive shaft 64. Refill of the grease 32 is accomplished by driving the external portion of the lead screw 48 and filling with a grease gun through the lubrication fitting 46.

While the illustrated embodiments show the pin insert 12 having two insert apertures 24 it will be understood that the pin insert 12 may include one or more than two apertures depending on the amount of grease required to lubricate the pin joint. Similarly the size of the apertures 24 may also vary provided that they allow sufficient quantity of lubricating agent to pass through to lubricate the pin joint. The position of the apertures 24 may also vary provided that they will align with pin apertures 26 and are positioned within the part of the chamber that the lubricating agent is in so that the action of the dispensing means forces the lubricating agent through the apertures.

While the present invention has been described relative to its use in a pin joint on an aircraft landing gear, it will be understood that the pin assembly and pin insert are not limited to this application and may be used in other applications that require the use of a pin assembly with the properties of that described herein.

Further it will be understood that any dimensions shown in the accompanying drawings are merely examples of the size of pin and pin insert that may be used and are not meant to be limiting in any way.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

Any publications, patents and patent applications referred to herein are incorporated by reference in their entirety to the same extent as if each individual publication, patent or patent application was specifically and individually indicated to be incorporated by reference in its entirety.

What is claimed is:

1. A lubricating pin insert for use in a hollow pin located in a pin joint on an aircraft landing gear, the pin having at least one aperture therein, the lubricating pin insert comprising:
a body having a chamber therein operable to receive a quantity of a lubricating agent, the body having at least one passageway therethrough in fluid communication with the chamber and configured to align with the at least one aperture of the pin when the insert is received therein; and
a dispensing means connected to the chamber and operable to dispense a quantity of lubricating agent from the chamber through the at least one passageway.

2. The lubricating pin insert according to claim 1 wherein the dispensing means comprises a pressure producing means connected to the chamber and a floating piston received within the chamber between the quantity of lubricating agent and the pressure producing means.

3. The lubricating pin insert according to claim 2, wherein the pressure producing means is a gas generator.

4. The lubricating pin insert according to claim 1, wherein the dispensing means comprises a floating piston located in the chamber adjacent the quantity of lubricating agent, the piston being operable to move within the chamber to dispense the lubricating agent therefrom.

5. The lubricating pin insert according to claim 4, wherein the floating piston is connected to control means operable to move the piston within the chamber.

6. The lubricating pin insert according to claim 5, wherein the control means is a motor.

7. The lubricating pin insert according to claim 5 wherein the control means is a ratchet assembly connected to the landing gear and is operable to move relative to the retracting and extension of the landing gear.

8. The lubricating pin insert according to claim 1, further comprising control means connected to the dispensing means for control thereof.

9. The lubricating pin insert according to claim 8, wherein the dispensing means and the control means are unitary.

10. The lubricating pin insert according to claim 4, wherein the piston is sized to extend across the width of the chamber and to move lengthwise therealong.

11. The lubricating pin insert according to claim 1, further comprising at least one lubrication inlet connected to the chamber to allow for passage of the lubricating agent into the chamber.

12. The lubricating pin insert according to claim 11, wherein the lubrication inlet includes a cap releasably connected thereto.

13. The lubricating pin insert according to claim 1, wherein the dispensing means is contained within the chamber.

14. A pin assembly for use in a pin joint on an aircraft landing gear, comprising:
a pin having a hollow body and at least one aperture therein;
a pin insert, sized to be received within the hollow body of the pin, comprising an internal chamber operable to receive a quantity of a lubricating agent and at least one passageway operable to allow passage of the lubricating agent from the chamber out of the insert; and
dispensing means connected to the chamber and operable to dispense a quantity of lubricating agent therefrom.

15. The pin assembly according to claim 14, wherein the at least one aperture and the at least one passageway are configured to allow passage of the lubricating agent therethrough when the pin insert is received in the pin.

16. The pin assembly according to claim 14, wherein the dispensing means comprises a gas generator connected to the chamber and a floating piston received within the chamber between the quantity of lubricating agent and the gas generator.

17. The pin assembly according to claim 14, wherein the dispensing means comprises a floating piston located in the chamber adjacent the quantity of lubricating agent, the piston being operable to move within the chamber to dispense the lubricating agent therefrom.

18. The pin assembly according to claim 17, wherein the floating piston is connected to control means operable to move the piston within the chamber.

19. The pin assembly according to claim 18, wherein the control means is a motor.

20. The pin assembly according to claim 18, wherein the control means is a ratchet assembly connected to the landing gear and is operable to move relative to the retracting and extension of the landing gear.

21. The pin assembly according to claim 14, further comprising control means connected to the dispensing means for control thereof.

22. The pin assembly according to claim 21, wherein the dispensing means and the control means are unitary.

23. The pin assembly according to claim 17, wherein the piston is sized to extend across the width of the chamber and to move lengthwise therealong.

24. The pin assembly according to claim 14, further comprising at least one lubrication inlet connected to the chamber to allow for passage of the lubricating agent into the chamber.

25. The pin assembly according to claim 14, wherein the lubrication inlet includes a one-way valve to allow for the filling of the chamber with the lubricating agent.

26. The pin assembly according to claim 14, wherein the lubrication inlet includes a cap releasably connected thereto.

27. A pin assembly for use in a pin joint, comprising:
a pin having a hollow body and at least one aperture therein;
a pin insert, sized to be received within the hollow body of the pin, comprising a body having an internal chamber at least a portion of which is operable to receive a quantity of a lubricating agent and at least one passageway operable to allow passage of the lubricating agent from the chamber out of the insert; and
a piston located within the chamber adjacent the portion operable to receive the lubricating agent, the piston being operable to move within the chamber and dispense a quantity of lubricating agent therefrom.

28. The pin assembly of claim 27, further comprising a pressure producing means connected to the chamber and operable to increase the pressure within the chamber to move the piston within the chamber.

29. A pin for use in a pin joint on an aircraft landing gear, comprising:
a hollow body operable to receive a quantity of a lubricating agent and comprising at least one passageway operable to allow passage of the lubricating agent from the body out of the pin, the pin further comprising dispensing means connected to the body and operable to dispense a quantity of lubricating agent therefrom.

30. The pin according to claim 29, wherein the dispensing means comprises a gas generator connected to the body and a floating piston received within the body between the quantity of lubricating agent and the gas generator.

31. The pin according to claim 29, wherein the dispensing means comprises a floating piston located in the body adjacent the quantity of lubricating agent, the piston being operable to move within the body to dispense the lubricating agent therefrom.

32. The pin according to claim 31, wherein the floating piston is connected to control means operable to move the piston within the body.

33. The pin according to claim 32, wherein the control means is a motor.

34. The pin according to claim 32, wherein the control means is a ratchet assembly connected to the landing gear and is operable to move relative to the retracting and extension of the landing gear.

35. The pin according to claim 29, further comprising control means connected to the dispensing means for control thereof.

36. The pin according to claim 35, wherein the dispensing means and the control means are unitary.

37. The pin according to claim 30, wherein the piston is sized to extend across the width of the chamber and to move lengthwise therealong.

38. The pin according to claim 29, further comprising at least one lubrication inlet connected to the body to allow for passage of the lubricating agent into the body.

39. The pin according to claim 38, wherein the lubrication inlet includes a one-way valve to allow for the filling of the body with the lubricating agent.

40. The pin according to claim 38, wherein the lubrication inlet includes a cap releasably connected thereto.
